(19) United States
(12) Patent Application Publication
(10) Pub. No.: US 2024/0351619 A1
(43) Pub. Date: Oct. 24, 2024

(54) Driving Assistance System and Driving Assistance Method for a Vehicle

(71) Applicant: Bayerische Motoren Werke Aktiengesellschaft, München (DE)

(72) Inventors: Yannick FORSTER, Muenchen (DE); Frederik NAUJOKS, Muenchen (DE)

(21) Appl. No.: 18/682,199

(22) PCT Filed: Aug. 29, 2022
(86) PCT No.: PCT/EP2022/073867

§ 371 Date: Feb. 8, 2024

(30) Foreign Application Priority Data
Sep. 8, 2021 (DE) 10 2021 123 232.5

(51) Int. Cl. B60W 60/00

(52) U.S. Cl. CPC B60W 60/0053; B60W 60/0057

(57) ABSTRACT

A driving assistance system for a vehicle includes at least one operating element for manual vehicle control; a training level determination unit that is configured to determine a first training level of a first vehicle occupant and a second training level of a second vehicle occupant; and a control unit that is configured to assign the at least one operating element for changing from an automated driving mode to a manual driving mode based on the first training level and the second training level to either the first vehicle occupant or the second vehicle occupant.

### BACKGROUND AND SUMMARY

The present disclosure relates to a driving assistance system for a vehicle, a vehicle with such a driving assistance system, a driving assistance method for a vehicle and a storage medium for executing the driving assistance method. The present disclosure relates in particular to a takeover of vehicle guidance by an occupant of an automated vehicle, in particular a motor vehicle.

Driving assistance systems for automated driving are becoming increasingly important. Automated driving can occur with different levels of automation. Examples of levels of automation include assisted, partially automated, conditionally automated, highly automated or fully automated driving. For example, in conditional automated driving, the driver does not need to continuously monitor the system. The vehicle takes over control of the vehicle and independently carries out, for example, a lane change or lane keeping. However, it must be possible for the driver to be able to take over control of the vehicle in response to a request from the driving assistance system if necessary within a certain advance warning time.

However, taking control of the vehicle by the driver poses safety risks. These safety risks particularly concern the ability of the driver to take control of the vehicle when requested to do so by the driving assistance system.

It is an object of the present disclosure to provide a driving assistance system for a vehicle, a vehicle with such a driving assistance system, a driving assistance method for a vehicle and a storage medium for executing the driving assistance method, which can improve safety in automated driving. In particular, it is an object of the present disclosure to reduce safety risks when an occupant of an automated vehicle takes over control of the vehicle.

This object is solved by the subject matter of the claimed invention.

According to an independent aspect of the present disclosure, a driving assistance system for a vehicle, in particular a motor vehicle, is specified. The driving assistance system comprises at least one operating element for manual vehicle control; a training level determination unit that is adapted to determine a first training level of a first vehicle occupant and a second training level of a second vehicle occupant; and a control unit that is adapted to assign the at least one operating element for changing from an automated driving mode to a manual driving mode based on the first training level and the second training level to either the first vehicle occupant or the second vehicle occupant.

The training level determination unit and the control unit can be implemented in a common software and/or hardware module. Alternatively, the training level determination unit and the control unit can each be implemented in separate software and/or hardware modules.

According to embodiments of the invention, when vehicle control is transferred to a vehicle occupant as part of a change from an automated driving mode to a manual driving mode, a suitable vehicle occupant is selected based on a training level. For example, in the case of a critical and unplanned takeover (e.g. in the event of a sensor failure) the vehicle occupant with the best or highest training level can obtain control of the vehicle. In another example, in the case of a non-critical and plannable takeover (e.g. in the case of a section of road ahead with known non-availability of the automated driving function), the vehicle occupant with the lowest training level can obtain control of the vehicle, so that this vehicle occupant can train to take over the vehicle control in non-critical and plannable situations.

This means that untrained people can be trained in relatively safe situations to master the switch to manual driving mode, whereas in serious situations the vehicle occupant with the most training is entrusted with guidance of the vehicle. This can reduce dangerous situations in current and/or future takeover scenarios. As a result, safety in automated driving can be improved.

Preferably, the first vehicle occupant is a driver of the vehicle or sits in a driver's seat, such as a front left or right seat. In this case, the second vehicle occupant may be a passenger of the vehicle or sit on a passenger seat such as a front right or left seat. Alternatively, the second vehicle occupant is a driver of the vehicle or sits in a driver's seat, such as a front left or right seat. In this case, the first vehicle occupant may be a passenger of the vehicle or sit on a passenger seat such as a front right or left seat.

The transfer of control of the vehicle is based on the training levels of the respective vehicle occupants. The term “training level” as used within the framework of the present disclosure refers to the individual driving ability of the driver. In particular, every person is able to drive a vehicle in a certain way. This capability may be categorized according to the embodiments of the present disclosure to thereby select a vehicle occupant to take over control of the vehicle.

Preferably, the training level is stored in a user profile of the corresponding vehicle occupant.

The training level can be determined in appropriate ways. In one example, the training level can be determined, in particular categorized, based on a (historical) number of takeovers of vehicle control. The number of takeovers indicates the number of changes from an automated driving mode (e.g. SAE level 3 or 4) to the manual driving mode (level 0), in which the corresponding vehicle occupant has taken over control of the vehicle.

In some embodiments, the vehicle occupant with the fewer or fewest number of takeovers may gain control of the vehicle (e.g. in the case of a non-critical and plannable takeover), or alternatively the vehicle occupant with the higher or highest number of takeovers may gain control of the vehicle (e.g. in the event of a critical and unplannable takeover, such as a sensor failure).

In another example, more complex methods can be used to determine the training level. For example, a method for determining a person-specific training level includes collecting situation-related data regarding driver behavior of the person, in particular a driver; and determining a person-specific training level of the person based on the situation-related data.

The situation-related data is preferably stored in a user profile. In some embodiments, the user profile may be a collection of data which contains data collected over time regarding the driver, such as reactions to certain traffic situations, preferences, etc.

Preferably, determining a person-specific training level includes classifying the user (i.e. a vehicle occupant, in particular a driver) into a predetermined category. The predetermined categories can be suitably specified or determined. For example, the predetermined category may be selected from the group comprising or consisting of a routine, practiced, average, little practiced and new driving situation. However, the present disclosure is not limited to these examples and other categories may be specified.

Preferably, the control unit is adapted to determine a criticality of a situation in relation to the change from the automated driving mode to the manual driving mode. In particular, situations can be characterized by a criticality or urgency. Some takeovers are not critical and proceed as planned since, for example, it is known well in advance that route availability (backup route data) is no longer available. Other takeovers, however, are critical and unplanned since, for example, one of the environmental sensors of the vehicle fails.

Preferably, the control unit is adapted to further assign the at least one operating element to either the first vehicle occupant or the second vehicle occupant based on the specific criticality of the situation.

Preferably, the control unit is adapted to assign the at least one operating element or the vehicle guidance to the vehicle occupant with the higher training level if the situation is assessed as critical, and to assign the at least one operating element or the vehicle guidance to the vehicle occupant with the lower training level if the situation is assessed as non-critical. This means that untrained people can be trained in relatively safe situations to master the switch to manual driving mode, whereas in serious situations the vehicle occupant with the most training is entrusted with the vehicle guidance.

In particular, several occupants can be located in the vehicle and have carried out a different number of manual control takeovers. This means that there may be a need for at least one vehicle occupant to train the takeovers. This can then be accomplished as part of non-critical and planned takeovers. In addition, it can be known which vehicle occupants have already carried out a large number of takeovers and show good performance, particularly in critical situations. This can reduce dangerous situations in future or current takeover scenarios.

Preferably, the control unit is adapted to assess the situation as critical if there is a first time budget or less for a takeover of vehicle control by the vehicle occupant, and to assess the situation as non-critical if there is a second time budget or more for a takeover of vehicle control by the vehicle occupant.

The second time budget can be larger than the first time budget.

The time budget can be defined as a period of time between the driving assistance system realizing that a change to manual mode is imminent and a time point at which the manual takeover of vehicle control must take place or have taken place. However, the present disclosure is not limited to this and the time budget can be suitably defined depending on the programming of the driving assistance system.

Preferably, the at least one operating element is selected from the group that includes, or consists of, a steering wheel, a joystick, a gas pedal and a brake pedal.

Preferably, the at least one operating element is a steering wheel, which is movable from one side of the vehicle to another side of the vehicle substantially perpendicular to a longitudinal axis of the vehicle. In particular, the steering wheel can be moved to the vehicle occupant who was selected to take over vehicle control based on the training level, so that the selected vehicle occupant can take over vehicle control.

The movement of the steering wheel substantially perpendicular to the longitudinal axis of the vehicle may be a horizontal movement perpendicular to the longitudinal axis of the vehicle and substantially parallel to a roadway. The term “horizontal” is to be understood in contrast to “vertical”. The term “horizontal” refers in particular to a horizontal orientation of the movement, wherein a deviation of a few degrees, e.g. up to 5° or even up to 10°, from an exact horizontal orientation is still considered to be “substantially horizontal”. The vertical direction, which runs transverse to the horizontal direction, may be substantially parallel to gravity.

However, the present disclosure is not limited to the above-mentioned example, and the at least one operating element may be selected from the group including or consisting of a movable operating element, non-movable operating element, unique operating element, redundant operating element, and combinations thereof.

Preferably, the at least one operating element comprises, or is, at least one joystick. The at least one joystick can be adapted for steering the vehicle (i.e. for the function of a steering wheel) and/or accelerating the vehicle (i.e. for the function of an accelerator pedal) and/or braking the vehicle (i.e. for the function of a brake pedal).

An example of a non-movable operating element is a single joystick for vehicle control. The joystick can, for example, be immovably present on a center console between the driver and the passenger, and can be operated both by the driver and by the passenger.

In another example of a non-movable operating element, redundant joysticks may be provided for vehicle control. For example, a corresponding joystick can be provided for each vehicle occupant, such as a joystick on the driver's seat and another joystick on the passenger seat, similar to the fly-by-wire system of aircraft.

Preferably, the control unit is adapted to assign the at least one operating element or the vehicle guidance to a vehicle occupant only if the vehicle occupant is able to take over or has sufficient ability to take over. For example, a vehicle occupant may be the primary choice for taking control of the vehicle due to their training level, but lack the ability to take over (e.g. if the vehicle occupant is sleeping, intoxicated and/or does not have a valid driving license). In this case, control of the vehicle can be handed over to another vehicle occupant, even if that occupant was not the primary choice with regard to training level.

The ability to take over is a measure of the ability of the vehicle occupant to take guidance of the vehicle. The ability to take over can be defined in a suitable way. For example, the ability to take over can be defined between 0% and 100%, wherein 0% indicates a lack of ability to take over (e.g. when the driver is sleeping) and 100% indicates unlimited ability to take over (e.g. when the driver is awake and concentrating on the road). In another example, the ability to take over may be defined in levels such as “no ability to take over,” “conditional ability to take over,” and “full ability to take over.”

Preferably, the control unit is further adapted to issue a driver instruction to take over vehicle guidance to the vehicle occupant selected based on the training level. For example, the driver instruction to take over vehicle guidance can be issued if the automated driving mode, for example, has to be deactivated due to unreliable sensor data (critical and unplannable handover) or if the automated driving mode is not available on a section of the route ahead (non-critical and plannable handover).

Preferably the driver instruction is a take-over request (TOR). The take-over request is a request from the driving assistance system to the vehicle occupant to take over guidance of the vehicle. In this case, e.g. lane departure warning system can be deactivated and vehicle guidance can be handed over to the vehicle occupant. For example, if uncertainty in lane detection becomes too great, the take-over request can be issued and the lane departure warning system can be deactivated.

Preferably, the driver instruction is issued to the vehicle occupant visually and/or acoustically and/or haptically.

In some embodiments, the driving assistance system may include at least one display device that is adapted to visually output or display the driver instruction. The display device can be provided, for example, in or on the dashboard of the vehicle.

The display device can be a head unit, for example. In some embodiments, the display device comprises an LCD display, a plasma display, or an OLED display. Additionally or alternatively, the vehicle can comprise at least one loudspeaker which is adapted to acoustically output the driver instructions. Additionally or alternatively, the vehicle can be adapted to issue the driving instructions haptically, for example, by a vibration of the steering wheel.

According to a further aspect of the present disclosure, a vehicle, in particular a motor vehicle, is provided. The vehicle comprises the driving assistance system according to the embodiments of the present disclosure.

The term vehicle includes cars, trucks, buses, mobile homes, motorcycles, etc. that are used to transport people, goods, etc. In particular, the term includes motor vehicles for passenger transport.

The driving assistance system is adapted for automated driving.

Within the framework of the document, the term “automated driving” can be understood to mean driving with automated longitudinal or lateral guidance or autonomous driving with automated longitudinal and lateral guidance. Automated driving can, for example, involve driving for a longer period of time on the motorway or time-limited driving as part of parking or maneuvering. The term “automated driving” comprises automated driving with any level of automation. Examples of levels of automation include assisted, partially automated, highly automated or fully automated driving. These levels of automation were defined by the Federal Highway Research Institute (BASt) (see BASt publication “Research Compact”, edition 11/2012).

During assisted driving, the driver permanently performs longitudinal or lateral guidance while the system takes over the respectively other function within certain limits. In partially automated driving (TAF), the system takes over longitudinal and lateral guidance for a certain period of time and/or in specific situations, whereby the driver must continuously monitor the system, as with assisted driving. In highly automated driving (HAF), the system takes over longitudinal and lateral guidance for a certain period of time without the driver having to permanently monitor the system; however, the driver must be able to take over guidance of the vehicle within a certain period of time. With fully automated driving (VAF), the system can automatically handle driving in all situations for a specific application; a driver is no longer required for this application.

The four levels of automation mentioned above correspond to SAE levels 1 to 4 of the SAE J3016 standard (SAE International—formerly Society of Automotive Engineering). Furthermore, SAE J3016 specifies SAE level 5 as the highest level of automation, which is not included in the BASt definition. SAE Level 5 corresponds to driverless driving, in which the system can automatically handle all situations throughout the journey like a human driver; a driver is generally no longer required.

The driving assistance system is preferably adapted for conditional automated driving. With such conditional automation of vehicle guidance, the driver does not have to continuously monitor the driving assistance system. The driving assistance system independently carries out functions such as triggering the turn signal, changing lanes and keeping in lane. However, it must be ensured that the driver can take over guidance of the vehicle if needed within a certain time when requested by the driving assistance system.

The driving assistance system is preferably adapted for conditional automated driving in accordance with SAE Level 3 or SAE Level 4.

According to a further independent aspect of the present disclosure, a driving assistance method for a vehicle, in particular a motor vehicle, is provided. The driving assistance method includes determining a first training level of a first vehicle occupant and a second training level of a second vehicle occupant; assigning at least one operating element for a manual vehicle control to either the first vehicle occupant or the second vehicle occupant based on the first training level and the second training level; and changing from an automated driving mode to a manual driving mode after assigning the at least one operating element.

The driving assistance method can implement the aspects of the driving assistance system described in this document.

According to another independent aspect of the present disclosure, a software (SW) program is provided. The SW program can be adapted to run on one or more processors and thereby carry out the driving assistance method described in this document.

According to another independent aspect of the present disclosure, a storage medium is provided. The storage medium may comprise a SW program which is adapted to be executed on one or more processors and thereby to carry out the driving assistance method described in this document.

According to a further independent aspect of the present disclosure, software with program code for carrying out the driving assistance method described in this document is to be executed when the software runs on one or more software-controlled devices.

Exemplary embodiments of the disclosure are shown in the figures and are described in more detail hereinafter.

### BRIEF DESCRIPTION OF THE DRAWINGS

FIG. 1 shows schematically a vehicle with a driving assistance system for automated driving according to embodiments of the present disclosure.

FIG. 2 shows schematically a driving assistance system according to embodiments of the present disclosure.

FIG. 3 shows schematically a handover of the vehicle control according to embodiments of the present disclosure.

FIG. 4 shows a flowchart of a driving assistance method according to embodiments of the present disclosure.

### DETAILED DESCRIPTION OF THE DRAWINGS

In the following, unless noted otherwise, the same reference numerals are used for elements that are the same and have the same effect.

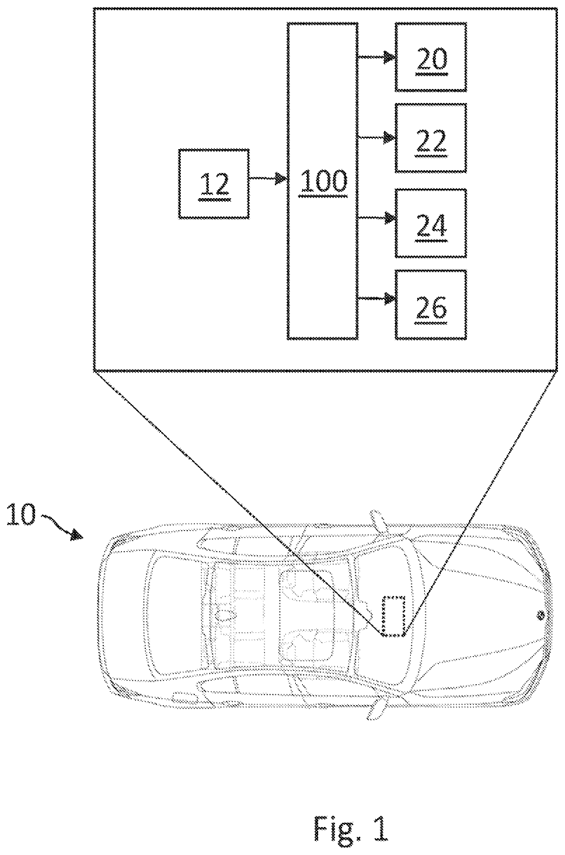

FIG. 1 shows schematically a vehicle 10 with a driving assistance system 100 for automated driving according to embodiments of the present disclosure.

During automated driving, the longitudinal and/or lateral guidance of the vehicle 10 takes place automatically. The driving assistance system 100 therefore takes over guidance of the vehicle. For this purpose, the driving assistance system 100 controls the drive 20, the transmission 22, the hydraulic service brake 24 and the steering 26 via intermediate units, not shown.

To plan and carry out automated driving, environmental information from an environmental sensor system that monitors the surroundings of the vehicle is received by the driver assistance system 100. In particular, the vehicle can include at least one environmental sensor 12, which is adapted to record environmental data that specifies the vehicle surroundings. The at least one environmental sensor 12 can comprise, for example, one or more several LiDAR systems, one or more radar systems, one or more cameras and/or one or more laser scanners.

Preferably, the driving assistance system 100 is adapted for conditional automated driving in accordance with SAE Level 3 or SAE Level 4.

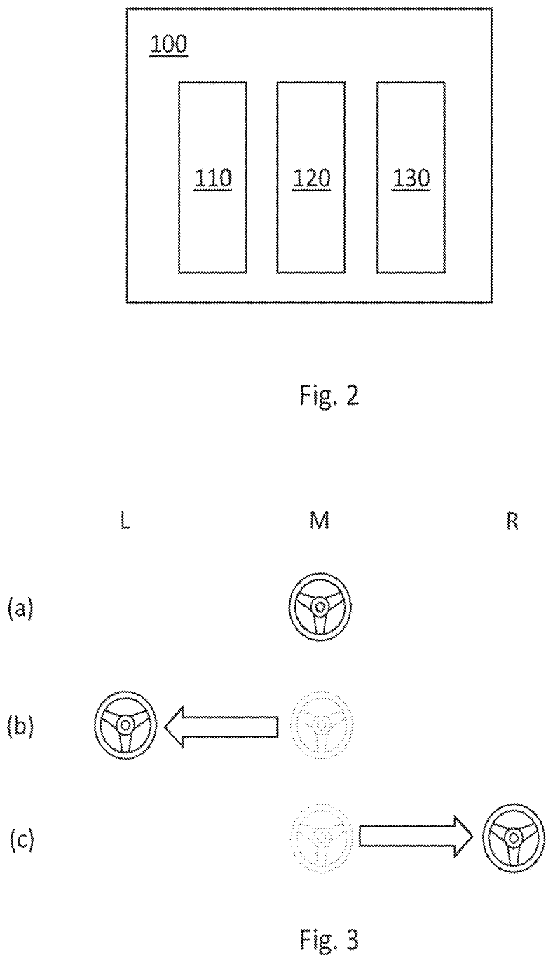

FIG. 2 shows schematically a driving assistance system 100 according to embodiments of the present disclosure.

The driving assistance system 100 comprises at least one operating element 110 for manual vehicle control; a training level determination unit 120, which is adapted to determine a first training level of a first vehicle occupant and a second training level of a second vehicle occupant; and a control unit 130, which is adapted to assign the at least one operating element 110 for a change from an automated driving mode to a manual driving mode based on the first training level and the second training level to either the first vehicle occupant or the second vehicle occupant.

For example, situations in which the change from automated driving mode to manual driving mode should or must take place can be characterized by different urgency.

Some takeovers are planned since, for example, it is known well in advance that route availability (e.g. from backup route data) is no longer available. In this case, more time budget is available and a long cascade of information can be made available to the driver so that the takeover is safe and convenient. This is advantageous, for example, for vehicle occupants with the lowest training level, so that these vehicle occupants can train to take over vehicle control in non-critical and plannable situations. Thus, for example, the ability to take over in future critical situations can be improved.

In contrast, other takeovers take place unplanned and/or in critical situations. Critical takeovers can be characterized by the fact that a smaller time budget is available since the handover cannot be planned in advance (such as in the event of a sensor failure), although a backup sensor system in automated driving can still provide a certain remaining budget within which vehicle guidance can be taken over. This means that in critical situations a handover to the most suitable vehicle occupant can be accomplished.

FIG. 3 shows schematically a handover of the vehicle control according to embodiments of the present disclosure.

According to embodiments of the invention, the at least one operating element 110 for manually controlling the vehicle is assigned to one of the vehicle occupants based on their individual training level. The at least one operating element can be, for example, a steering wheel that can be moved from one side of the vehicle to another side of the vehicle substantially perpendicular to a longitudinal axis of the vehicle.

In the example of FIG. 3(a), the steering wheel is positioned centrally (M) between the first vehicle occupant L and the second vehicle occupant R during automated driving. If the first vehicle occupant L is selected to take over control of the vehicle based on his training level, the steering wheel may move toward the first vehicle occupant L (FIG. 3(b)). However, if the second vehicle occupant R is selected to take over vehicle control based on his training level, the steering wheel may move towards the second vehicle occupant R (FIG. 3(c)).

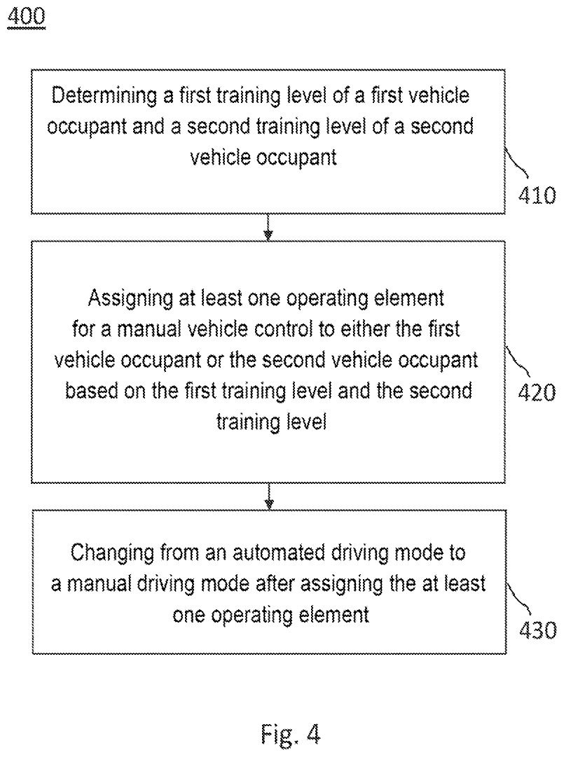

FIG. 4 schematically shows a flowchart of a driving assistance method 400 according to embodiments of the present disclosure. The driving assistance method 400 can be implemented by appropriate software that can be executed by one or more processors (e.g. a CPU).

The driving assistance method 400 includes, in block 410, determining a first training level of a first vehicle occupant and a second training level of a second vehicle occupant; in block 420, assigning at least one operating element for manual vehicle control to either the first vehicle occupant or the second vehicle occupant based on the first training level and the second training level; and in block 430, changing from an automated driving mode to a manual driving mode after assigning the at least one operating element.

According to embodiments of the invention, when vehicle control is transferred to a vehicle occupant as part of a change from an automated driving mode to a manual driving mode, a suitable vehicle occupant is selected based on a training level. For example, in the case of a critical and unplanned takeover (e.g. in the event of a sensor failure) the vehicle occupant with the best or highest training level can receive control of the vehicle. In another example, in the case of a non-critical and plannable takeover (e.g. in the case of a section of road ahead with known non-availability of the automated driving function), the vehicle occupant with the lowest training level can receive control of the vehicle, so that this vehicle occupant can train to take over the vehicle control in non-critical and plannable situations.

This means that untrained people can be trained in relatively safe situations to master the switch to manual driving mode, whereas in serious situations the vehicle occupant with the most training is entrusted with guidance of the vehicle. This can reduce dangerous situations in current and/or future takeover scenarios. As a result, safety in automated driving can be improved.

Although the invention has been illustrated and explained in detail by preferred exemplary embodiments, the invention is not limited by the examples disclosed and other variations may be derived therefrom by the person skilled in the art without departing from the scope of the invention. It is therefore clear that a large number of possible variations exist. It is also clear that embodiments mentioned as examples are truly examples only which should not be construed in any way as limiting the scope, application possibilities, or configuration of the invention. Rather, the preceding description and the description of the figures enable the person skilled in the art to specifically implement the exemplary embodiments, whereby the person skilled in the art can make a variety of changes, for example with regard to the function or the arrangement of individual elements mentioned in an exemplary embodiment, in the knowledge of the disclosed inventive concept, without departing from the scope of protection, which is defined by the claims and their legal equivalents, such as further explanations in the description.

1.-10. (canceled)

11. A driving assistance system for a vehicle, the driving assistance system comprising:
at least one operating element for manual vehicle control;
a training level determination unit which is configured to determine a first training level of a first vehicle occupant and a second training level of a second vehicle occupant; and
a control unit which is configured to assign the at least one operating element for a change from an automated driving mode to a manual driving mode based on the first training level and the second training level to either the first vehicle occupant or the second vehicle occupant.

12. The driving assistance system according to claim 11, wherein the control unit is further configured to:
determine a criticality of a situation in relation to the change from the automated driving mode to the manual driving mode, and
assign the at least one operating element further based on the criticality of the situation to either the first vehicle occupant or the second vehicle occupant.

13. The driving assistance system according to claim 12, wherein the control unit is further configured to:
assign the at least one operating element to the vehicle occupant with a higher training level upon assessing the situation as critical, and
assign the at least one operating element to the vehicle occupant with a lower training level upon assessing the situation as non-critical.

14. The driving assistance system according to claim 13, wherein:
the control unit is further configured to assess the situation as critical upon determining that there is a first time budget or less for the vehicle occupant to take over vehicle control, and to assess the situation as non-critical upon determining that a second time budget or more is provided for the vehicle occupant to take over vehicle control, and
the second time budget is greater than the first time budget.

15. The driving assistance system according to claim 11, wherein the at least one operating element is selected from the group consisting of a steering wheel, a joystick, a gas pedal and a brake pedal.

16. The driving assistance system according to claim 11, wherein the at least one operating element is a steering wheel which is movable substantially perpendicular to a longitudinal axis of the vehicle from one side of the vehicle to another side of the vehicle.

17. The driving assistance system according to claim 11, wherein the automated driving mode corresponds to SAE Level 3 or SAE Level 4.

18. The vehicle comprising the driving assistance system according claim 11.

19. A driving assistance method for a vehicle, the driving assistance method comprising:
determining a first training level of a first vehicle occupant and a second training level of a second vehicle occupant;
assigning at least one operating element for manual vehicle control to either the first vehicle occupant or the second vehicle occupant based on the first training level and the second training level; and
changing from an automated driving mode to a manual driving mode after assigning the at least one operating element.

20. A computer product comprising a non-transitory computer readable medium having stored thereon program code which, when executed on one or more processors, caries out the driving assistance method according to claim 19.
